(19) United States
(12) Patent Application Publication
(10) Pub. No.: US 2007/0285505 A1
(43) Pub. Date: Dec. 13, 2007

(54) METHOD AND APPARATUS FOR VIDEO CONFERENCING HAVING DYNAMIC LAYOUT BASED ON KEYWORD DETECTION

(75) Inventor: Jan Tore KORNELIUSSEN, Oslo (NO)

Correspondence Address: OBLON, SPIVAK, MCCLELLAND MAIER & NEUSTADT, P.C., 1940 DUKE STREET, ALEXANDRIA, VA, 22314, US

(73) Assignee: Tandberg Telecom AS, Lysaker (NO)

(21) Appl. No.: 11/754,651

(22) Filed: May 29, 2007

(30) Foreign Application Priority Data
May 26, 2006 (NO) 20062418

(51) Int. Cl. H04N 7/14

(52) U.S. Cl. 348/14.08; 348/E07.083

(57) ABSTRACT

In particular, the present invention provides a method and system for conferencing, including the steps of connecting at least two sites to a conference, receiving at least two video signals and two audio signals from the connected sites, consecutively analyzing the audio data from the at least two sites connected in the conference by converting at least a part of the audio data to acoustical features and extracting keywords and speech parameters from the acoustical features using speech recognition, and comparing said extracted keywords to predefined words, then deciding if said extracted predefined keywords are to be considered a call for attention based on said speech parameters, and further, defining an image layout based on said decision, and processing the received video signals to provide a video signal according to the defined image layout, and transmitting the composite video signal to at least one of the at least two connected sites.

### FIELD OF THE INVENTION

The invention is related to image layout control in a multisite video conference call, where focus of attention is based on voice analysis.

### BACKGROUND

Video conferencing systems allow for simultaneous exchange of audio, video and data information among multiple conferencing sites. Systems known as multipoint control units (MCUs) perform switching functions to allow multiple sites to intercommunicate in a conference. The MCU links the sites together by receiving frames of conference signals from the sites, processing the received signals, and retransmitting the processed signals to appropriate sites. The conference signals include audio, video, data and control information. In a switched conference, the video signal from one of the conference sites, typically that of the loudest speaker, is broadcast to each of the participants. In a continuous presence conference, video signals from two or more sites are spatially mixed to form a composite video signal for viewing by conference participants. When the different video streams have been mixed together into one single video stream the composed video stream is transmitted to the different parties of the video conference, where each transmitted video stream preferably follows a set scheme indicating who will receive what video stream. In general, the different users prefer to receive different video streams. The continuous presence or composite image is a combined picture that may include live video streams, still images, menus or other visual images from participants in the conference.

In a visual communication system it is often desirable to recreate the properties of a face-to-face meeting as close as possible. One advantage of a face-to-face meeting is that a participant can direct his attention to the person he is talking to, to see reactions and facial expressions clearly, and adjust the way of expression accordingly. In visual communication meetings with multiple participants the possibility for such focus of attention is often limited, for instance due to lack of screen space or limited picture resolution when viewing multiple participants, or because the number of participants is higher than the number of participants viewed simultaneously. This can reduce the amount of visual feedback a speaker gets from the intended recipient of a message.

Most existing multipart visual communication systems have the possibility of devoting more screen space to certain participants by using various screen layouts. Two common options are to view the image of one participant at a time on the whole screen (Voice switched layout), or to view a larger image of one participant and smaller images of the other participants on the same screen (N+1 layout). There are many variants of these two basic options, and some systems can also use multiple screens to alleviate the lack of physical space on a single screen. Focus of attention can therefore be realized by choosing an appropriate screen layout where one participant is enhanced, and the method by which a participant is given focus of attention may vary.

A common method is to measure voice activity to determine the currently active speaker in the conference, and change main image based on this. Many systems will then display an image of the active speaker to all the inactive speakers, while the active speaker will receive an image of the previously active speaker. This method can work if there is a dialogue between two persons, but fails if the current speaker addresses a participant different from the previous speaker. The current speaker in this case might not receive significant visual cues from the addressed participant until he or she gives a verbal response. The method will also fail if there are two or more concurrent dialogues in a conference with overlapping speakers.

Some systems let each participant control his focus of attention using an input device like a mouse or remote control. This has fewer restrictions compared to simple voice activity methods, but can easily be distracting to the user and disrupt the natural flow of dialogue in a face-to-face meeting.

Other systems allow an administrator external to the conference to control the image layout. This will however be very dependent on the abilities of the administrator, and is labor intensive. It might also not be desirable if the topic of conversation is confidential or private.

US 2005/0062844 describe a video teleconferencing system combining a number of features to promote a realistic “same room” experience for meeting participants. These features include an autodirector to automatically select, from among one or more video camera feeds and other video inputs, a video signal for transmission to remote video conferencing sites. The autodirector analyzes the conference audio, and according to one embodiment, the autodirector favors a shot of a participant when his or her name is detected on the audio. However, this will cause the image to switch each time the name of a participant is mentioned. It is quite normal that names of participants are brought up in a conversation, without actually addressing them for a response. Constant switching between participants can both be annoying to the participants and give the wrong feedback to the speaker.

Therefore, it is the object of the present invention to overcome the problems discussed above.

### SUMMARY OF THE INVENTION

It is an object of the present invention to provide a system and method that eliminates the drawbacks described above. The features defined in the independent claim enclosed characterize this system and method. In particular, the present invention provides a method for conferencing, including the steps of connecting at least two sites to a conference, receiving at least two video signals and two audio signals from the connected sites, consecutively analyzing the audio data from the at least two sites connected in the conference by converting at least a part of the audio data to acoustical features and extracting keywords and speech parameters from the acoustical features using speech recognition, and comparing said extracted keywords to predefined words, then deciding if said extracted keywords are to be considered a call for attention based on said speech parameters, and further, defining an image layout based on said decision, and processing the received video signals to provide a video signal according to the defined image layout, and transmitting the processed video signal to at least one of the at least two connected sites.

Further the present invention discloses a system for conferencing comprising:

An interface unit for receiving at least audio and video signals from at least two sites connected in a conference.

A speech recognition unit for analyzing the audio data from the at least two sites connected in the conference by converting at least a part of the audio data to acoustical features and extracting keywords and speech parameters from the acoustical features using speech recognition.

A processing unit configured to compare said extracted keywords with predefined words, and deciding if said extracted keywords are to be considered a call for attention based on said speech parameters.

A control processor for dynamically defining an image layout based on said decision, and a video processor for processing the received video signals to provide a composite video signal according to the defined image layout.

### BRIEF DESCRIPTION OF THE DRAWINGS

The foregoing and other objects, features and advantages of the invention will be apparent from the following more particular description of preferred embodiments of the invention, as illustrated in the accompanying drawings in which identical reference characters refer to the same parts throughout the different views. The drawings are not necessarily to scale, emphasis instead being placed upon illustrating the principles of the invention.

FIG. 1 is an illustration of video conferencing endpoints connected to an MCU

FIG. 2 is a schematic overview of the present invention

FIG. 3 illustrates a state diagram for Markov modelling

FIG. 4 illustrates the network structure of the wordspotter

FIG. 5 illustrates the output stream from the wordspotter

FIG. 6 is a schematic overview of the word model generator

### DETAILED DESCRIPTION

In the following, the present invention will be discussed by describing a preferred embodiment, and by referring to the accompanying drawings. However, people skilled in the art will realize other applications and modifications within the scope of the invention as defined in the enclosed independent claims.

The presented invention determines the desired focus of attention for each participant in a multipart conference by assessing the intended recipients of each speaker's utterance, using speech recognition on the audio signal from each participant to detect and recognize utterances of names of other participants, or groups of participants. Further, it is an object of the present invention to provide a system and method to distinguish between proper calls for attention, and situations where participants or groups are merely being referred to in the conversation. The focus of attention is realized by altering the image layout or audio mix presented to each user.

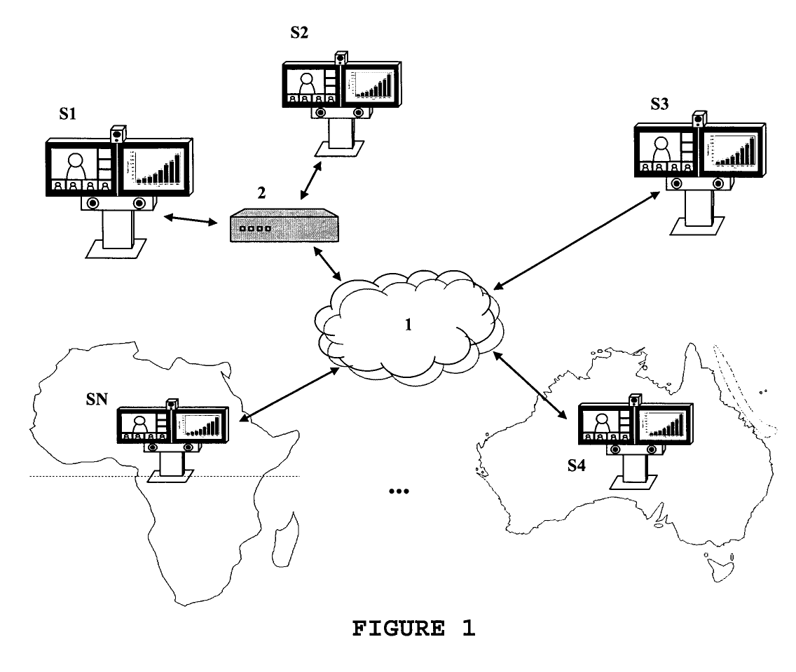

Throughout the specification, the term “site” is used to refer collectively to a location having an audiovisual endpoint terminal and a conference participant or user. Referring now to FIG. 1, there is shown an embodiment of a typical video conferencing setup with multiple sites (S1-SN) interconnected through a communication channel (1) and an MCU (2). The MCU links the sites together by receiving frames of conference signals from the sites, processing the received signals, and retransmitting the processed signals to appropriate sites.

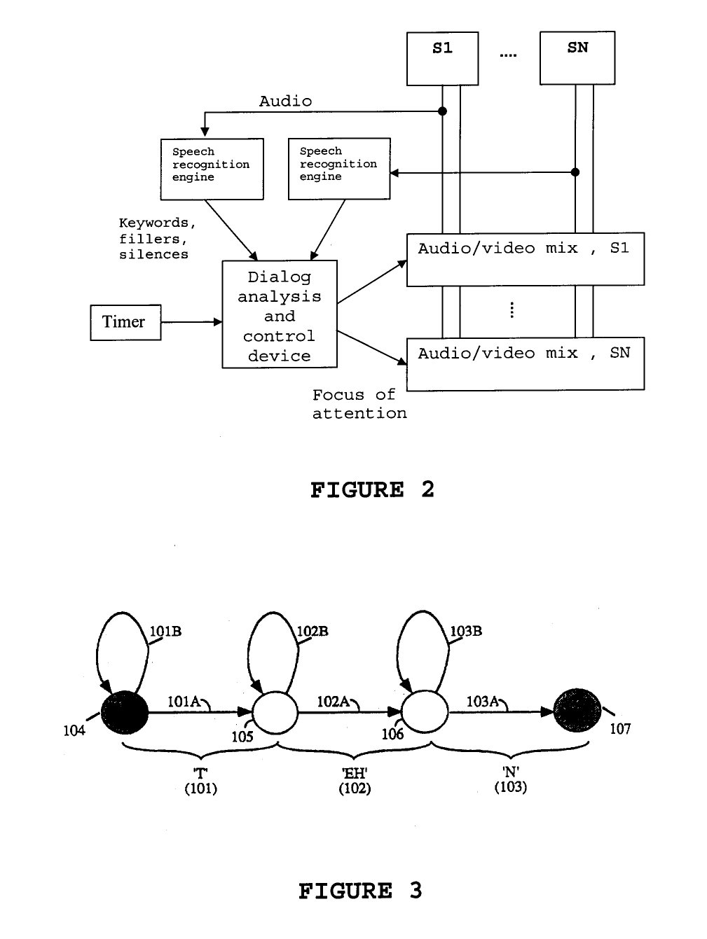

FIG. 2 is a schematic overview of the system according to the present invention. Acoustical data from all the sites (S1-SN) are transmitted to a speech recognition engine, where the continuous speech is analyzed. The speech recognition algorithm will match the stream of acoustical data from each speaker against word models to produce a stream of detected name keywords. In the same process speech activity information is found. Each name keyword denotes either a participant or group of participants. The streams of name keywords will then enter a central dialog model and control device. Using probability models and the stream of detected keywords, and other information like speech activity and elapsed time, the dialog model and control device determine the focus of attention for each participant. The determined focus of attention determines the audio mix and video picture layout for each participant.

To implement the present invention, a robust and effective speech recognition method for use in the speech recognition engine is required. Speech recognition, in its simplest definition, is the automated process of recognizing spoken words, i.e. speech, and then converting that speech to text that is used by a word processor or some other application, or passed to the command interpreter of the operating system. This recognition process consists of parsing digitized audio data into meaningful segments. The segments are then mapped against a database of known phonemes and the phonetic sequences are mapped against a known vocabulary or dictionary of words.

In speech recognition, hidden Markov models (HMMs) are often used. When an HMM speech recognition system is built, each word in the recognizable vocabulary is defined as a sequence of sounds, or a fragment of speech, that resemble the pronunciation of the word. A Markov model for each fragment of speech is created. The Markov models for each of the sounds are then concatenated together to form a sequence of Markov models that depict an acoustical definition of the word in the vocabulary. For example, as shown in FIG. 3, a phonetic word 100 for the word “TEN” is shown as a sequence of three phonetic Markov models, 101-103. One of the phonetic Markov models represents the phonetic element “T” (101), having two transition arcs 101A and 101B. A second of the phonetic Markov models represents the phonetic element “EH”, shown as model 102 having transition arcs 102A and 102B. The third of the phonetic Markov models 103 represents the phonetic element “N” having transition arcs 103A and 103B.

Each of the three Markov models shown in FIG. 3 has a beginning state and an ending state. The “T” model 101 begins in state 104 and ends in state 105. The “EH” model 102 begins in the state 105 and ends in state 106. The “N” model 103 begins in state 106 and ends in state 107. Although not shown, each of the models actually has states between their respective beginning and ending states in the same manner as arc 101A is shown coupling states 104 and 105. Multiple arcs extend and connect the states. During recognition, an utterance is compared with the sequence of phonetic Markov models, starting from the leftmost state, such as state 104, and progressing according to the arrows through the intermediate states to the rightmost state, such as state 107, where the model 100 terminates in a manner well-known in the art. The transition time from the leftmost state 104 to the rightmost state 107 reflects the duration of the word. Therefore, to transition from the leftmost state 104 to the rightmost state 107, time must be spent in the “T” state, the “EH” state and the “N” state to result in a conclusion that the utterance is the word “TEN”. Thus, a hidden Markov model for a word is comprised of a sequence of models corresponding to the different sounds made during the pronunciation of the word.

In order to build a Markov model, such as described in FIG. 3, a pronunciation dictionary is often used to indicate the component sounds. Various dictionaries exist and may be used. The source of information in these dictionaries is usually a phonetician. The components sounds attributed to a word as depicted in the dictionary are based on the expertise and senses of the phonetician.

There are other ways of implementing speech recognition, e.g. by using neural networks alone or in combination with Markov models, which may be used with the present invention.

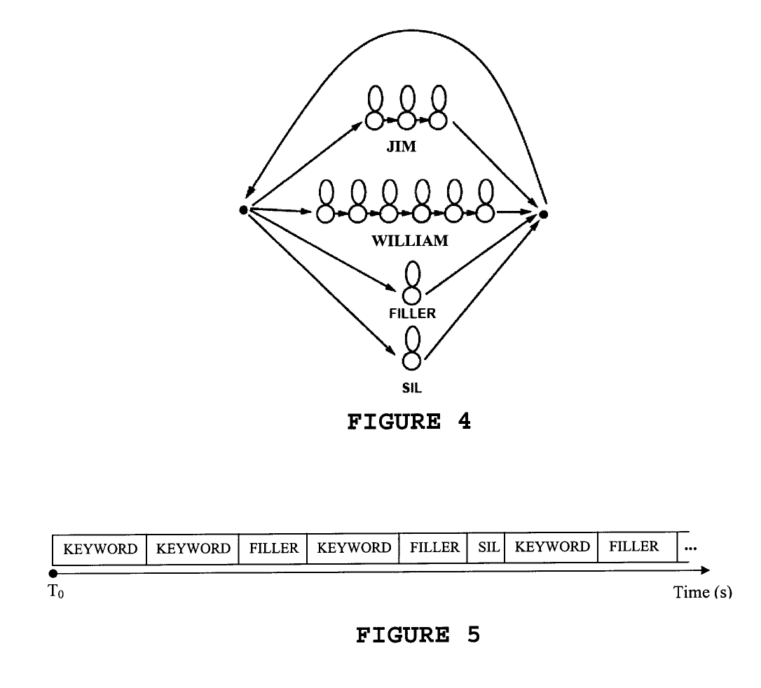

According to one embodiment of the present invention, only certain words are of particular interest. The technique for recognizing specific words in continuous speech is referred to as “word spotting” or “keyword spotting”. A Word spotting application require considerably less computation than continuous speech recognition, e.g. for dictating purposes, since the dictionary is considerably smaller. When using a word spotting system, a user speaks certain keywords embedded in a sentence and the system detects the occurrence of these keywords. The system will spot keywords even if the keyword is embedded in extraneous speech that is not in the system's list of recognizable keywords. When users speak spontaneously, there are many grammatical errors, pauses, and inarticulacy that a continuous speech recognition system may not be able to handle. For these situations, a word spotting system will concentrate on spotting particular keywords and ignore the extraneous speech. As shown in FIG. 4, each keyword to be spotted is modeled by a distinct HMM, while speech background and silence are modeled by general filler and silence models respectively.

One approach is to model the entire background environment, including silence, transmission noises and extraneous speech. This can be done by using actual speech to create one or more HMMs, called filler or garbage models, representative of extraneous speech. In progress, the recognition system creates a continuous stream of silence, keywords and fillers, and the occurrence of a keyword in this output stream is considered as a putative hit. FIG. 5 shows a typical output stream from the speech recognition engine, where To denotes the beginning of an utterance.

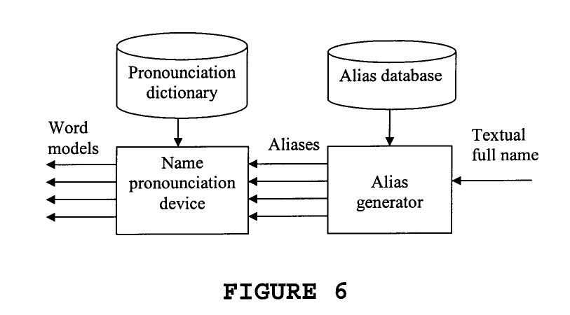

In order for the speech recognition engine to recognize names in the audio stream, it requires a dictionary of word models for each participant or group of participants in a format suitable for the given speech recognition engine. FIG. 6 shows a schematic overview of a word model generator according to one embodiment of the present invention. The word models are generated from the textual names of the participants, using a name pronunciation device. The name pronunciation device can generate word models using either pronunciation rules, or a pronunciation dictionary of common names. Further, similar word models can be generated for other words of interest.

Since each participant is likely to be denoted by several different aliases of their full name in a conference, the name pronunciation device is preceded by an alias generator, which will generate aliases from a full name. In the same way as for pronunciations, aliases can be constructed either using rules or a database of common aliases. Aliases of “William Gates” could for instance be “Bill”, “Bill Gates”, “Gates”, “William”, “Will” or “WG”.

Using pronunciations rules or dictionaries of common pronunciations will result in a language dependent system, and requires a correct pronunciation in order for the recognition engine to get a positive detection. Another possibility is to generate the word models in a training session. In this case each user would be prompted names and/or aliases, and be asked to read the names/aliases out load. Based on the user's pronunciation, the system generates word models for each name/alias. This is a well known process in small language independent speech recognition systems, and may be used with the present invention.

The textual names of participants can be provided by existing communication protocol mechanisms according to one embodiment of the present invention, making manual data entry of names unnecessary in most cases. The H.323 protocol and the Session Initiation Protocol (SIP) are telecommunication standards for real-time multimedia communications and conferencing over packet-based networks, and are broadly used for videoconferencing today. In a local network with multiple sites, each site possesses its own unique H.323 ID or SIP Uniform Resource Identifier (URI). In many organizations, the H.323 ID's and SIP URI's for personal systems are similar to the name of the system user by convention. Therefore, a personal system would be uniquely identified with an address looking something like this:
name.surname@organization.com

By acquiring the system ID or URI, the textual names can be extracted by filtering so that they are suitable for word model generation. The filtering process could for instance be to eliminate non-alphanumeric characters and names which are not human-readable (com, net, gov, info etc.).

If the personal systems are only identifiable by a number (telephone number, employee number, etc), a lookup table could be constructed where all the ID-number are associated with the respective users names.

For conference room systems used by multiple participants at the same time, the participant names can be collected from the management system if the unit has been booked as part of a booking service. In addition to the participant names, which are automatically acquired, the system can be preconfigured with a set of names which denote groups of participants, e.g. “Oslo”, “Houston”, “TANDBERG”, “The board”, “human resources”, “everyone”, “people”, “guys”, etc.

In any given conference it is a possibility that two or more participants have the same full name or same alias. However, one can assume that the participants in a conference choose to use aliases which have a unique association to a person. In order to disambiguate aliases which have a non-unique association to a person, the system according to the invention maintains a statistical model of the association between alias and participant. The model is constructed before the conference starts, and is based on the mentioned assumed uniqueness, and are updated during the conference with data from the dialog analysis.

As discussed above, not all utterances of names are a call for attention. During a conference with multiple participants, references are usually made to numerous persons, e.g. referring to previous work on a subject, reports, appointing tasks, etc. In order to reduce the number of false positives, the invention employs a dialogue model which gives the probability of a name keyword being a proper call for attention. The model is based on the occurrence of the name keywords in relation to the utterance and dialog. In addition to the enhanced recognition of name keywords, the dialog analysis can provide other properties of the dialog like fragmentation into sub dialogs.

Therefore, in order to differentiate between a proper call for attention and mere references, a dialog model according to the present invention considers several different speech and dialog parameters. Important parameters include placement of a keyword within an utterance, volume level of keyword, pauses/silence before and/or after a keyword, etc.

The placement of the name keyword within an utterance is an important parameter for determining the probability of a positive detection. It is quite normal in any setting with more than 2 persons present, to start an utterance by stating the name of the person you want to address, e.g. “John, I have looked at . . . ” or “So, Jenny. I need a report on . . . ”. This is, of course, because you want assurance that you have the full attention of the person you are addressing. Therefore, calls for attention are likely to occur early in an utterance. Hence, occurrences of name keywords early in an utterance increase the probability of a name calling.

Further, a name calling is often followed by a short break or pause in the utterance. If we look at the two examples above where the speaker obviously seeks John's and Jenny's attention;
“John, I have looked at . . . ” and “So, Jenny. I need a report on . . . ”
   , and compare them to a situation where the speaker only refers to John and Jenny;
“Yesterday, John and I looked at . . . ” and “I told Jenny that I needed . . . ”
   , we see that the speaker pauses shortly after the names in the first two examples, and that no such pause is present in the two latter examples. Therefore, breaks and pauses preceding, succeeding, or both preceding and succeeding a name keyword, in the speaker's utterance increases the likeliness of a name calling. Similarly, absence of such breaks and pauses decreases the likeness of a name calling.

The dialog model may also consider certain words as “trigger” keywords. Detected trigger keywords preceding or succeeding a name keyword, increases the likeliness of a name calling. Such words could for instance be “Okay”, “Well”, “Now”, “So”, “Uuhhm”, “here”, etc.

In a similar way, certain trigger keywords detected preceding a name keyword should decrease the likeliness of a name calling, and decrease the likeliness of a name calling. Such keywords could for instance be “this is”, “that is”, “where”, etc.

Another possibility is to consider the prosody of the utterance. At least in some languages, name callings are more likely to have certain prosody. When a speaker is seeking attention from another participant, it is likely that the name is uttered with a slightly higher volume. The speaker might also emphasize on the first syllable of the name, or increase or decrease the tonality and/or speed of the last syllable depending on positive or negative feedback, respectively.

This is just a few examples of speech or dialog parameters considered by the dialog model. Speech and dialog parameters are gathered and evaluated in the dialog model, where each parameter contributes positively or negatively when determining if a name keyword is a call for attention or not. In order to optimize the parameters, and build a complete set of parameters and rules, considerable amounts of real dialog recordings must be analyzed.

Further, the system comprises a dialogue control unit. The dialog control unit controls the focus of attention each participant is presented with. E.g. if a detected name keyword X is considered a call for attention by the dialog model, the dialog model sends a control signal to the dialog control device, informing the dialog control device that a name calling to user X at site S1 has been detected in the audio signal from site S2. The dialog control unit then mixes the video signal for each user, in such a way that at least site S2 receives an image layout focusing on site S1. Focusing on site S1 means that either all the available screen space is devoted to S1, or if a composite layout is used, a larger portion of the screen is devoted to S1 compared to the other participants.

Further, the dialog control device preferably comprise a set of switching criteria's to prevent disturbing switching effects, such as rapid focus changes caused by frequent name callings, interruptions, accidental utterances of names, etc.

Sites with multiple participants situated in the same room may cause unwanted detections and consequently switching. If one of the participants shortly interrupts the speaker by uttering a name, or mentions a name in the background, this may be interpreted as a name calling by the dialog model. To avoid this, the system must be able to distinguish between the participants voices, and disregard utterances from voices other than the loudest speaker.

The various devices according to the invention need not be centralized in a MCU, but can be distributed to the endpoints. The advantages of distributed processing is not only limited to reduced resource usage in the central unit, but can in the case of personal systems also ease the process of speaker adaptation since there is no need for central storage and management of speaker properties.

Compared to systems based on simple voice activity detection, the described invention has the ability to show the desired image for each participant, also in complex dialog patterns. It is not limited to the concept of active and inactive speakers when determining the view for each participant. It also distinguishes between proper calls for attention and mere name references in the speakers utterance.

Compared to systems which let users select their view using simple input methods, it gives a more seamless experience similar to a face-to-face meeting, since there is no need to interrupt the dialog with distracting device control. Since the keywords used for detecting intended recipient often are present in normal dialog, the system will feel natural to use, and will give the user much the benefit of the mechanism without knowing about the feature beforehand or require special training.

It also has a great cost and privacy advantage compared to view control by an operator external to the conference.

1. A method of conferencing comprising:
connecting at least two sites to a conference;
receiving at least two video signals and two audio signals from the connected sites;
consecutively analyzing the audio data from the at least two sites connected in the conference by converting at least a part of the audio data to acoustical features and extracting keywords and speech parameters from the acoustical features using speech recognition;
comparing said extracted keywords to predefined words, and deciding if said extracted keywords are to be considered a call for attention based on said speech parameters;
defining an image layout based on said decision;
processing the received video signals to provide a video signal according to the defined image layout; and
transmitting the processed video signal to at least one of the at least two connected sites.

2. The method according to claim 1 wherein the method further comprises the steps of:
predefining words where the words are defined as being one or more of the following: names of participants in the conference, groups of participants in the conference, aliases of said names;
other predefined keywords, wherein said keywords are speech parameters

3. The method according to claim 2 further comprising at the detection of a name,
gathering speech parameters relating to said detected name wherein each parameter weighs positive or negative when determining the likeliness of said name being a call for attention

4. The method according to one of the claims 2-3 further comprising upon a positive call for attention decision,
redefining the image layout focusing on the video signal associated with said detected predefined name or alias, processing the received video signals to provide a second composite video signal according to the redefined image layout; and transmitting the second composite video signal to at least one of the connected sites.

5. The method according to one of the claims 2-4 further comprising the step of;
extracting said names of participants, and/or names of groups of participants, from a conference management system if said conference has been booked through a booking service.

6. The method according to one of the claims 2-4 further comprising the steps of;
acquiring each sites unique ID or URI; and
processing said unique IR or URI to automatically extract said names of participants , and/or groups of participants.

7. The method according to one of the claims 2-3 further comprising the step of:,
deriving a set of aliases for each said name by means of an algorithm and/or a database of commonly used aliases.

8. A system for conferencing comprising:
an interface unit for receiving at least audio and video signals from at least two sites connected in a conference;
a speech recognition unit for analyzing the audio data from the at least two sites connected in the conference by converting at least a part of the audio data to acoustical features and extracting keywords and speech parameters from the acoustical features using speech recognition;
a processing unit configured to compare said extracted keywords to predefined words, and deciding if said extracted keywords are to be considered a call for attention based on said speech parameters;
a control processor for dynamically defining an image layout based on said decision;
a video processor for processing the received video signals to provide a processed video signal according to the defined image layout.

9. The system according claim 8, wherein the system is further configured to
redefine the image layout based on said decision, focusing on the video signal corresponding to said extracted predefined keywords, processing the received video signals to provide a second composite video signal according to the redefined image layout; and
transmitting the second video signal to at least one of the connected sites.

10. The system according to claim 8, wherein said predefined words are categorized as one or more of the following:
names of participants in the conference,
groups of participants in the conference,
aliases of said names;
other predefined keywords, wherein said keywords are speech parameters

11. The system according to claim 8 wherein the speech recognition unit upon the detection of a name, is further configured to;
gather said speech parameters relating to said detected name, and determine the likeliness of said detected name being a call for attention based on said speech parameters, wherein each said speech parameter weighs positive or negative in the decision process.

12. The system according to one of the claims 8-11 wherein the speech recognition unit further comprises,
means for extracting said names of participants, and/or names of groups of participants, from a conference management system if said conference was booked through a booking service.

13. The system according to one of the claims 8-12 wherein the speech recognition unit further comprises,
means for acquiring each sites unique ID or URI; and
means for processing said unique IR or URI to automatically extract said names of participants, and/or groups of participants.

14. The system according to one of the claims 8-13 wherein the speech recognition unit further comprises,
means for deriving a set of aliases for each said participant or group of participants based on algorithms and/or a database of commonly used aliases.
